(19) United States
(12) Patent Application Publication
(10) Pub. No.: US 2008/0205105 A1
(43) Pub. Date: Aug. 28, 2008

(54) VOLTAGE CONVERTER

(75) Inventor: ALBERT MISSONI, Graz (AT)

Correspondence Address: DICKSTEIN SHAPIRO LLP, 1177 AVENUE OF THE AMERICAS 6TH AVENUE, NEW YORK, NY, 10036-2714, US

(73) Assignees: Infineon Technologies Austria AG, Villach (AT); Technische Universitaet Graz, Graz (AT)

(21) Appl. No.: 11/687,816

(22) Filed: Mar. 19, 2007

(30) Foreign Application Priority Data
Feb. 28, 2007 (DE) 10 2007 009 838.5

(51) Int. Cl. H02M 7/34; H04B 7/14

(52) U.S. Cl. 363/108

(57) ABSTRACT

A voltage converter having an input unit, a transitional unit configured to convert an AC voltage provided by the input unit into a transitional voltage and at least one auxiliary transitional voltage, and an output unit configured to convert the transitional voltage to a DC voltage using a charge pump unit, the charge pump unit being supplied with the at least one auxiliary transitional voltage as a control signal.

### CROSS-REFERENCE TO RELATED APPLICATION

This application claims priority to German Patent Application Serial No. 10 2007 009 838.5, which was filed Feb. 28, 2007, and is incorporated herein by reference in its entirety.

### BACKGROUND

A large number of options are known today for transmitting data in a digital radio communication system, for example in RFID system. Depending on the respective system, this involves the data being transmitted between a transponder, for example in the form of a radio tag, and a reader. The transition medium used in this context is an electromagnetic field. Specifically in passive radio communication systems (RFID tags), the DC supply voltage for operating the transponder is obtained from the electromagnetic field. This manner of obtaining voltage means that no separate power supply, for example in form of a battery, needs to be accommodated on the transponder. It is therefore possible to make the transponder smaller and more lightweight and hence to acquire a broader field of use for the transponders.

To obtain a supply voltage, energy is accordingly drawn from the electromagnetic field. The energy in the electromagnetic field propagates in the form of electromagnetic waves. An electromagnetic wave is a wave of coupled electrical and magnetic fields which has a carrier frequency defined as an oscillation of the electromagnetic field. An input unit in a transponder converts this oscillation of the electromagnetic field into an electrical AC voltage. By way of example, this is achieved by means of an input resonant circuit in which two energy stores are designed and tuned with one another such that they resonate when excited by means of an electromagnetic wave which has a particular carrier frequency and convert the electromagnetic wave into an electrical AC voltage. To obtain a DC supply voltage, this AC voltage is converted into a stable DC voltage. In this case, a person skilled in the art refers to rectification of an AC voltage signal. To rectify an AC voltage, bridge rectifier arrangements are used, for example. These bridge rectifiers have components which have a diode characteristic and are conducting or non-conducting according to the applied AC voltage half-cycle. A pulsating DC voltage produced in this manner is leveled by means of a large capacitance. A person skilled in the art refers to smoothing this pulsating DC voltage.

Electronic circuits in transponders as mentioned above require, in addition to the rectifier, a charge pump in order to produce a suitable operating voltage. In this context, the charge pump shifts the voltage potential at the output of the rectifier to an appropriate level of potential.

The high frequencies of the electromagnetic field mean that Schottky diodes are used in a charge pump arrangement today. Their nature means that these diodes are capable of switching the AC voltages at the high carrier frequencies. Their physical nature means that they have relatively poor energy efficiency values for this conversion, however. In this context, efficiency is defined as being the ratio of available field energy to DC voltage power obtained. The high input frequencies of the electromagnetic field have to date largely prevented the use of MOS technologies for application in charge pumps.

### BRIEF DESCRIPTION OF THE DRAWINGS

The invention is explained below using exemplary embodiments with reference to the drawing, where components which are the same or have the same action are respectively shown with the same reference symbols in the figures. The elements shown are not to be considered as true to scale, but rather individual elements can be shown exaggeratedly large or exaggeratedly simplified in order to improve understanding.

FIG. 1 shows a block diagram of a voltage converter for generating a DC operating voltage,

FIG. 2 shows a more detailed block diagram of the voltage converter from FIG. 1,

FIG. 3 shows a principle circuit for an input and rectification unit,

FIG. 4 shows a refinement of the circuit shown in FIG. 3, and

FIG. 5 shows possible signal profiles for the basic circuit.

### DESCRIPTION OF THE INVENTION

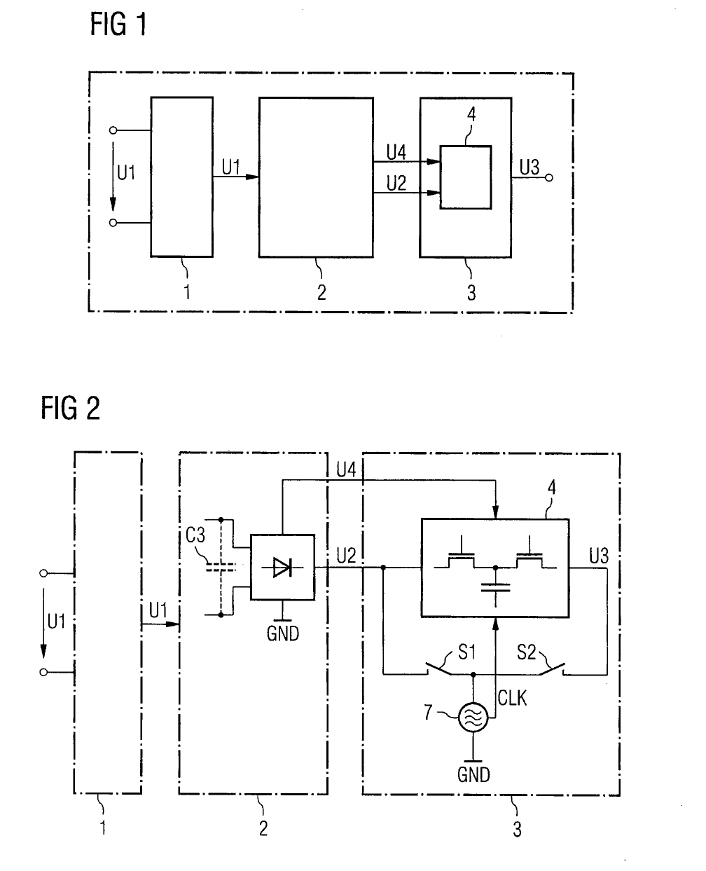

FIG. 1 shows a block diagram of a voltage converter as may be used in RFID systems. It shows an input unit 1, a transitional unit 2 and an output unit 3. The input unit 1 has connections for applying an AC voltage U1. This AC voltage is allocated to the transitional unit 2 by means of the input unit 1. At the output of the transitional unit 2, a transitional voltage U2 and an auxiliary transitional voltage U4 are made available to a charge pump unit 4 in the output unit 3. At the output of the output unit 3, a DC voltage U3 is allocated.

The input unit 1 makes the AC voltage U1 available to the transitional unit 2. Within the transitional unit 2, a transitional voltage U2 and an auxiliary transitional voltage U4 are generated from this AC voltage U1. These generated voltages U2 and U4 are applied to the charge pump unit 4 contained in the output unit 3. The transitional voltage U2 and the auxiliary transitional voltage U4 are used to provide the DC voltage U3 at the output of the charge pump unit 4.

FIG. 2 shows a detailed block diagram of an input unit 1, a transitional unit 2 and an output unit 3 as shown in FIG. 1. The input unit 1 allocates an AC voltage to the transitional unit 2. The transitional unit 2 includes an input capacitor C3 and a rectification unit. This unit generates a transitional voltage and an auxiliary transitional voltage U2 and U4 and allocates both voltages to the output unit 3. In the output unit 3, a charge pump unit 4 is shown whose input is supplied with the transitional voltage U2. The input of the charge pump unit 4 is also connected to an oscillator 7 via a switch S1. The oscillator output CLK furthermore is connected to an additional input of the charge pump unit 4. The output of the charge pump unit 4 is connected to the oscillator 7 and to the switch S1 via a switch S2. Also, the DC voltage U3 is available at the output of the charge pump unit 4. In addition, the auxiliary transitional voltage U4 is connected to a control input of the charge pump unit 4.

The AC voltage U1 which is present in the input unit 1 is supplied to the transitional unit 2. In this case, the capacitor C3 is an input capacitor. Together with a coil (not shown) in the input unit 1, an input parallel resonant circuit is therefore produced which converts an electromagnetic field into an electrical AC voltage U1. In this case, the capacitor C3 is not provided as an extra component but rather is the parasitic capacitance of the rectification unit. The rectification unit converts the AC voltage U1 into a transitional voltage U2 and an auxiliary transitional voltage U4, which are both available to the charge pump unit 4. The auxiliary transitional voltage U2 is connected to the oscillator 7 by means of the switch S1. When the voltage U2 is generated, the initially closed switch S1 is used to actuate the oscillator 7 with the voltage U2 and to generate a clock signal CLK which is delivered to the charge pump unit 4. In the further progression, the charge pump unit 4 will generate a DC voltage U3 which is essentially more stable and more heavily loadable than the transitional voltage U2. So as not to load the astable transitional voltage U2 unnecessarily, the switch S1 is opened and the switch S2 is closed in a further step. This means that the signal U3 is applied to the oscillator by means of the switch S2. The voltage U3 therefore replaces the voltage U2 as the supply voltage for the oscillator. The clock signal CLK which is also generated is delivered to the charge pump unit, too. While U2 is applied to the oscillator, the operation of the charge pump is called startup mode. One fundamental advantage is that the transitional voltage signal U2 is not loaded. The operation of the charge pump unit is not described in more detail here.

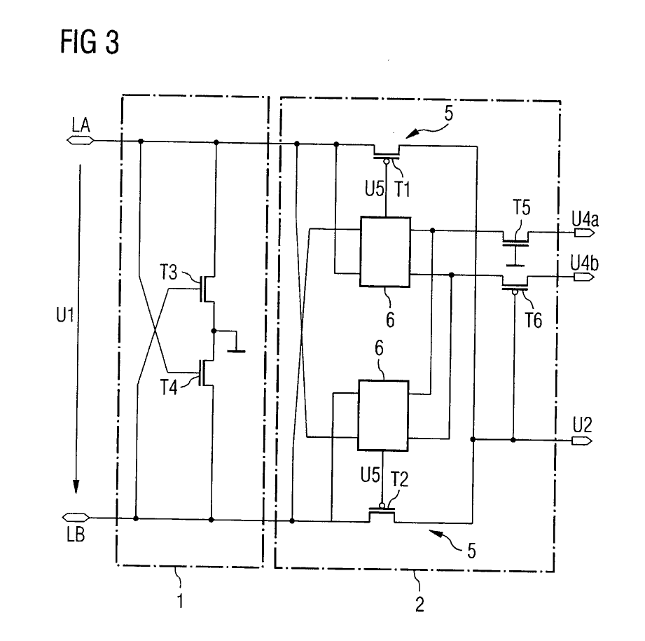

FIG. 3 now shows a principle circuit of the input unit 1 and the transitional unit 2. The inputs LA and LB of the input unit 1 are used to apply an AC voltage U1. A reference potential transistor T3 has its drain connection connected to the input LA. The source connection of T3 is connected to the drain of a further reference potential transistor T4. The drain connection of T4 is also connected to the reference potential GND. The source of T4 is connected to the connection LB. LB is also connected to the gate of T3, whereas LA is connected to the gate of T4. In addition, LA is connected to the drain connection of a PMOS transistor T1, which is continually referred to as a switching unit transistor. The source of T1 is used to produce the transitional voltage U2. The same applies to the switching unit transistor T2, whose source is connected to the transitional voltage potential and whose drain is connected to LB. In addition, the transitional unit 2 has two control units 6. The two control units respectively have a connection to LA and LB. The control units 6 are respectively connected to one of the gate connections of T1 and T2. In this case, the gate connections of the transistors T1 and T2 are at the potential U5. The two control units 6 have connections to the respective drains of transistors T5 and T6. T5 and T6 are continually referred to as auxiliary transitional transistors. The gate of T5 is connected to ground. The source connection is denoted by U4a and provides a positive auxiliary transitional voltage. The transistor T6 is a PMOS transistor and its sources have the potential U4b, which is referred to as negative auxiliary transitional voltage.

The applied AC voltage U1 is now divided into half-cycles. If we first of all consider the positive half-cycle of U1, the input unit connection LA will be at a higher potential than LB. This higher potential turns on the transistor T4. This links the reference potential GND to the potential LB. When considering the positive half-cycles, the input LA is therefore at a positive potential and the input LB is at reference potential GND. If the control units 6 now produce a more negative voltage U5 than this reference potential and apply it to the gate of transistor T1, the transistor T1 is on and produces a transitional voltage U2 even at low input voltages on connection LA. The same applies respectively to the negative half-cycle. Essentially, T3 is turned on and therefore reference point LA is applied to the ground potential GND. If the control unit 6 now generates a more negative gate voltage U5 on the transistor T2, LB is connected to U2 even at low input voltages in this case too. In addition, the control units 6 generate auxiliary transitional voltages U4a and U4b, which can have a negative and/or a positive arithmetic sign.

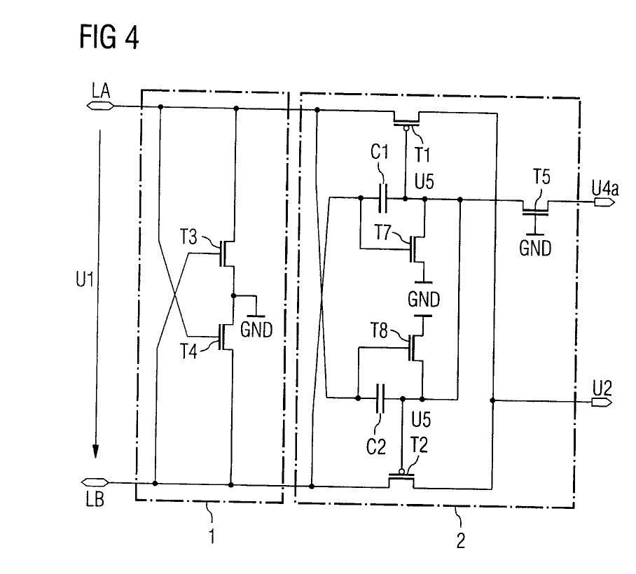

FIG. 4 in turn shows the input unit 1, designed as in FIG. 3, and a refinement option for the transitional unit 2. Unlike in FIG. 3, this exemplary embodiment comprises a detailed illustration of the control units 6. In terms of content, control unit 6 is made up of a control capacitor C1 and a control transistor T7 or a control capacitor C2 and a control transistor T8. The source of the transistor T7 is connected to ground potential and the gate of transistor T7 is connected to the capacitor C1 and to the input connection LB. The second connection of the capacitor C1 is connected to the gate connection of T1, is therefore at the reference potential U5 and is linked to the drain connection of the transistor T7 and to the drain connection of T5. When LB becomes positive, LA is at reference potential GND, in this regard see the description relating to FIG. 3. It follows from this that C1 is charged to potential U5. The transistor T7 is on when the positive LB voltage is actuated. The capacitor C1 has therefore been charged positively, since point U5 is at reference potential GND. For the negative half-cycle of AC voltage U1, LB is now forced to reference potential GND and LA is supplied with a positive voltage. The fact that LB is at reference potential GND and the capacitor C1 has been charged causes a charge shift and hence a more negative voltage U5. This voltage is now applied to the gate of transistor T1, which has already been described as negative biasing. This brief negative biasing causes the transistor T1 to turn on even at lower AC voltages U1 with respect to the transitional voltage U2.

In this manner, it is also possible to use radio-frequency input AC voltages of more than 500 MHz using MOS transistors and accordingly to achieve a higher level of energy efficiency. By actuating the charge pump unit 4 using a mid-frequency signal CLK, the use of Schottky diodes is no longer necessary there either. First, it is possible to implement more efficient charge pumps, and in addition the charge pump units do not have to be implemented in multistage form. This achieves space saving and hence a reduction in the size of the circuit.

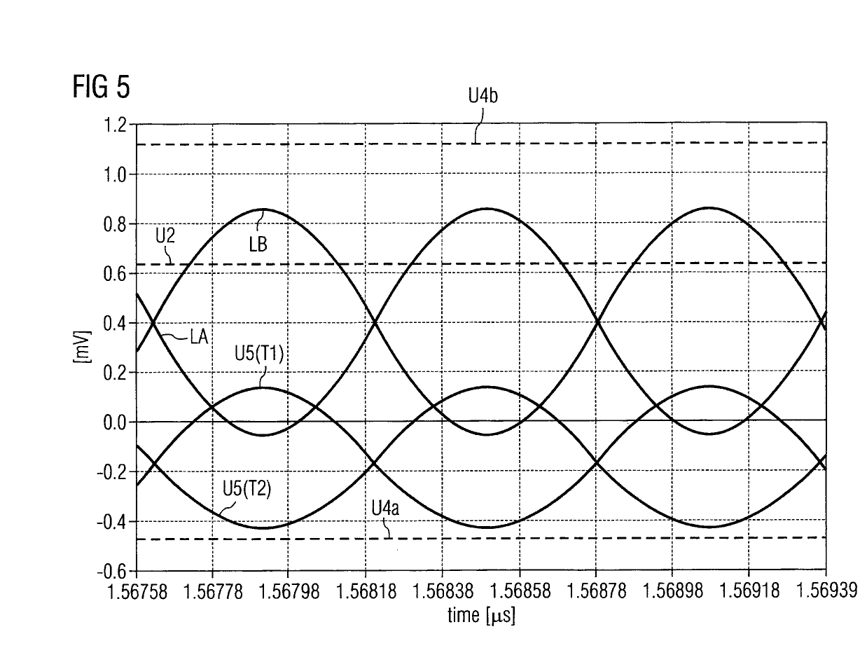

For the purposes of illustration, FIG. 5 shows possible signal profiles for the voltages U1 (LA and LB), U2, U4a, U4b, U5(T1) and U5(T2). In this case, the voltages LA and LB are sinusoidal voltages at a frequency of 870 MHz. The control units 6 are used to produce the transitional voltage U2, the auxiliary transitional voltages U4a and U4b and the control voltage U5(T1) and U5(T2).

The voltage U1 is split into the voltages LA and LB, which have a 180 degree phase shift, by means of the transistors T3 and T4. The reference potential GND, which is the same for both, is likewise defined by the transistors T3 and T4. The transitional voltage U2 produced is already heavily rectified in this FIG. 5, since the capacitors C1 and C2 have a low capacitance and can discharge only to a small extent on account of the high frequency of 870 MHz. The control voltage U5 is, as described, essentially more negative than the associated drain voltage of the transistors T1 and T2 in both cases, the effect achieved being early switching of these transistors T1 and T2.

This rectifier operates for various frequency bands, since rapid switching is achieved through such connection of the gate connections to the control units 6. For the purposes of optimizing to the individual frequency bands, it is also possible to produce what is known as an area/frequency ratio by connecting in further transistors and hence to allow switching matched to the frequency range.

What is claimed is:

1. A voltage converter comprising:
an input unit;
a transitional unit configured to convert an AC voltage provided by the input unit into a transitional voltage and at least one auxiliary transitional voltage; and
an output unit configured to convert the transitional voltage to a DC voltage using a charge pump unit, the charge pump unit being supplied with the at least one auxiliary transitional voltage as a control signal.

2. The voltage converter according to claim 1, wherein the transitional unit comprises at least one control unit configured to produce the at least one auxiliary transitional voltage.

3. The voltage converter according to claim 2, wherein the transitional unit comprises a switching unit configured to produce the transitional voltage.

4. The voltage converter according to claim 3, wherein the control unit produces a control voltage used as a control signal for the switching unit.

5. The voltage converter according to claim 3, wherein the control unit produces only an auxiliary transitional voltage which is both a control signal for the charge pump unit and a control signal for the switching unit.

6. The voltage converter according to claim 1, wherein the charge pump unit is implemented with transistors as switching elements, and the auxiliary transitional voltage is a control signal for these switching elements.

7. The voltage converter according to claim 1, wherein the AC voltage has a frequency of at least 400 MHz.

8. The voltage converter according to claim 1, wherein the switching unit produces the transitional voltage from the AC voltage.

9. The voltage converter according to claim 8, wherein the switching unit is implemented with two transistors.

10. The voltage converter according to claim 1, wherein the input unit allocates the AC voltage as a reference potential using the transistors.

11. The voltage converter according to claim 1, wherein the charge pump unit is operated with an oscillator, and the oscillator produces a clock signal at a frequency below 4 MHz.

12. The voltage converter according to claim 11, wherein the transitional voltage is supplied by a switch or the DC voltage is supplied by a switch to the oscillator as an operating voltage.

13. The voltage converter according to claim 1, wherein the input capacitance of the transitional unit is minimal.

14. A digital radio communication system having a transponder comprising the voltage converter of claim 1.

15. The digital radio communication system of claim 14, wherein the digital radio communication system is an RFID system, and the transponder is radio tag.

16. A voltage converter comprising:
a rectification unit which has connections for applying an AC voltage and is configured to produce an intermediate voltage and at least one actuation voltage; and
a charge pump unit configured to convert the intermediate voltage into an output voltage, and to be is controllable by the intermediate voltage for conversion purposes.

17. The apparatus according to claim 16, wherein the rectification unit comprises at least one control unit configured to produce the at least one actuation voltage.

18. The apparatus according to claim 17, wherein the rectification unit comprises a switching unit configured to produce the intermediate voltage.

19. The apparatus according to claim 16, wherein the charge pump unit is operated with an oscillator, and the oscillator produces a clock signal at a frequency below 4 MHz.

20. The apparatus according to claim 16, wherein the AC voltage has a frequency of at least 500 MHz and is converted to the intermediate voltage by the switching unit.

21. The apparatus according to claim 16, wherein the charge pump unit is operated with transistors as switching elements, and these transistors are actuated by the actuation voltage.

22. A voltage converter comprising:
an input unit;
a transitional means for converting an AC voltage provided by the input unit into a transitional voltage and at least one auxiliary transitional voltage; and
an output means for converting the transitional voltage to a DC voltage using a charge pump unit, the charge pump unit being supplied with the at least one auxiliary transitional voltage as a control signal.
